(19) United States
(12) Patent Application Publication
(10) Pub. No.: US 2005/0125583 A1
(43) Pub. Date: Jun. 9, 2005

(54) Detecting method for PCI system

(76) Inventor: Ken Shih, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/842,521

(22) Filed: May 11, 2004

(30) Foreign Application Priority Data
Dec. 3, 2003 (TW) 092133956

(51) Int. Cl. G06F 13/24

(52) U.S. Cl. 710/260

(57) ABSTRACT

A detecting method for PCI system is provided for accurately detecting the PCI system bugs rapidly. The PCI system comprises a central process unit, a basic input/output system (BIOS), a PCI controller chipset, a PCI bus and at least one PCI device. The detecting method comprises mainly the following steps: providing an interrupt service routine; enabling an interrupt register of the PCI device by the interrupt service program to ask the PCI device send an interrupt request; and detecting whether received the interrupt request in a predetermined period for recognizing the interrupt function. Furthermore, the invention further provides a PCI register read/write testing, a PCI control signal testing and a PCI data bus testing to improve the efficiency of quality control and test procedure.

### FIELD OF THE INVENTION

This invention relates to a detecting method for PCI system; more particularly, to accurately recognize the PCI system bugs rapidly.

### DESCRIPTION OF THE PRIOR ART

In the past, The PCI( peripheral component interconnection) system of computer structure used by industry is as shown in FIG. 1. The computer system (10) consists of one central processor unit (12), one chipset (14), one memory (18) and one PCI slot (16). Among them, the central processor unit (12) is responsible for the entire computer operation, including read of instruction, execution of instruction, memory access and storage, data input/output, etc. Memory (18) is used to store instruction information of the system. The chipset (14) is responsible for coordination and arbitration between the central processor unit (12) and other system components. PCI slot (16) is used to connect the first PCI device 161 and the second PCI device 163 and other PCI devices to expand the function of a computer system, such as local area network connection execution, modem dialing or connection of wireless network, etc.

Following the continue development of information technology and the endless improvement of the semiconductor manufacturing process, the demand for the efficiency of the computer is getting even higher. The requirement for the function of a computer is getting more sophisticated. In order to meet the demand of the consumer on the basic equipments of a computer, more and more functional circuits are put into one control chip (e.g. North Bridge and South Bridge) by manufactures. Similarly, more and more of the computer peripheral devices, such as PCI device, are directly built into the main board of computer. It does not only reduce the overall product cost, and also avoid the trouble for the user to purchase the PCI device separately. It can also avoid the difficulty of unable to use the computer as a result of the conflict between the add-on interface card and the computer setting.

The more PCI devices are built into the main board, the more functions can be provided by the computer system. On the contrary, it is the more complicated to debug the system if mistake happens. It often happens that the computer system passes all PCI function test but still can not work properly.

### SUMMARY OF THE INVENTION

It is therefore a primary object of the present invention to provide a detecting method for PCI system to accurately recognize the PCI system bugs rapidly, which utilizes an interrupt service routine to detect the interrupt function.

There is another object of the present invention to provide a detecting method for PCI system by enabling an interrupt register of the PCI device by the interrupt service routine to ask the PCI device send an interrupt request for recognizing the interrupt function.

Another object of the present invention is to provide a detecting method for PCI system using a detecting procedure to detect if the interrupt register of the basic input/output system is enabled, and if the interrupt routing selection table is correct.

Another object of the present invention is to provide a detecting method for PCI system by detecting whether the layout of the interrupt signal line and the interrupt function of the PCI device are correct, in order to clarify the bugs of problems, for further providing solutions to resolve the bugs.

For achieving the primary and other objects, the present invention provides a detecting method for PCI system. The PCI system comprises at least a central process unit, a basic input/output system, a chipset including a PCI controller, a PCI bus and at least one PCI device. The detecting method comprises mainly the following steps: providing an interrupt service routine; enabling an interrupt register of the PCI device by using the interrupt service routine to ask the PCI device send an interrupt request; and detecting whether received the interrupt request in a predetermined period for recognizing the interrupt function. Furthermore, the invention further provides a read/write test of the PCI register, a PCI control signal test and a PCI data bus test to improve the efficiency of quality control and test procedure.

### BRIEF DESCRIPTION OF THE DRAWINGS

The accompanying drawings which are incorporated in and form a part of this specification, illustrate embodiments of the invention and together with the description, serve to explain the principles of the invention:

FIG. 1 is a block diagram of conventional computer architecture;

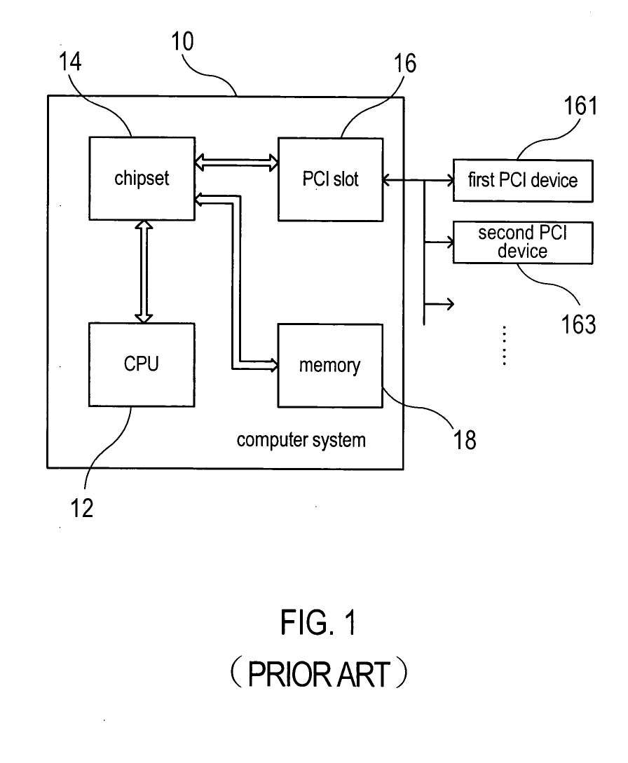

FIG. 2 is a block diagram of the computer architecture of the present invention;

FIG. 3 is a flow diagram of a preferred embodiment of the present invention; and

FIG. 4 is a flow diagram of detecting method of bug of interrupt of the present invention.

### DETAILED DESCRIPTION OF THE INVENTION

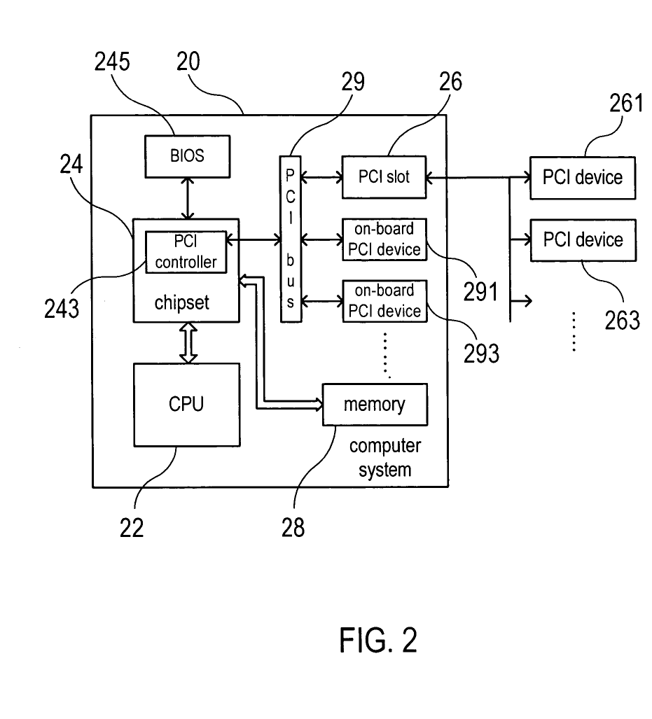

Reference will now be made in detail to the preferred embodiments of the invention. Please refer to FIG. 2, which shows the schematic diagram of the PCI system of the state-of-the-art computer architecture. As shown in the drawing, the computer system 20 mainly includes a central processing unit 22, a chipset 24 including a PCI controller 243, a basic input/output system 245, a memory 28, and a PCI bus 29. The PCI bus 29 is connect to a PCI slot 26 for receiving a plurality of external PCI devices 261 and 263, etc. The PCI bus 29 is further connected to a plurality of on-board PCI devices 291 and 293, etc.

In the past, the function expansion of the computer system is done by adding external PCI device card. Therefore, if the PCI slot 26 is properly connected with PCI bus 29, and the PCI device 261 and 263 can pass function test, there will usually be no problem happens. However, when the main board is built with a plurality of on-board PCI device 291 and 293, the proper operation of the system is related to the design and manufacture of the main board, and can not be proved only by function test of the PCI devices.

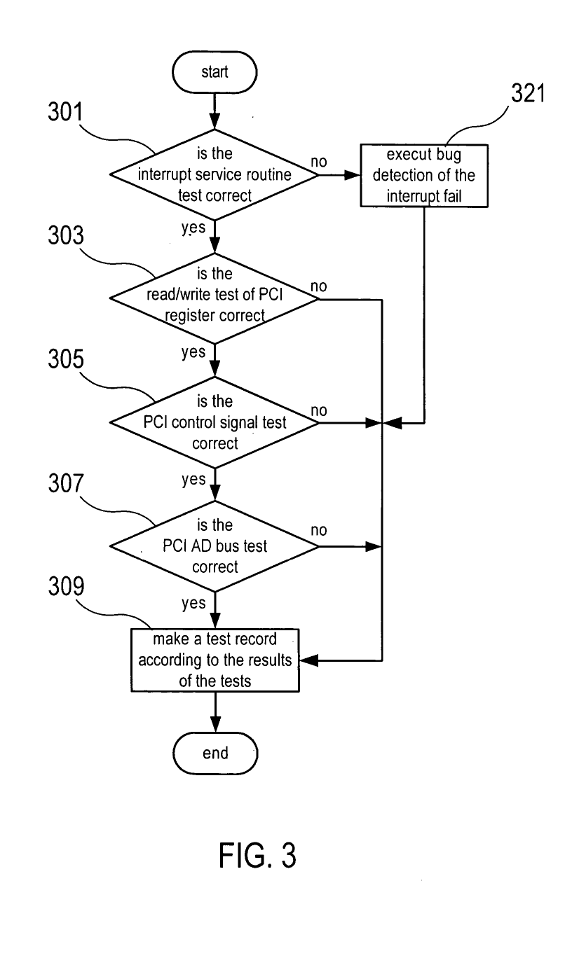

Please refer to FIG. 3, which shows the flow diagram of a preferred embodiment of the present invention. In order to make sure the computer system with on-board PCI devices (as the computer architecture including PCI system shown in FIG. 2) can properly operate, and to rapidly detect bugs when the system malfunctions. The present invention provides a detecting method of PCI system, which mainly comprises the following steps: providing an interrupt service routine in the system test program, and detecting if the interrupt request is correctly sent and received using the interrupt service routine (shown in block 301). If the interrupt request is not correct, the bug detection of the interrupt fail is executed (shown in block 321) to certify the cause of the problem. If the interrupt request is correct, then is interrupt function is correct, which means the layout of the interrupt signal line of the main board and the connection of the pins of the on-board PCI device is correct, then other function test of the PCI devices.

Consequently, the PCI register read/write testing of the PCI device is executed to make sure if the function of the PCI device is correct (shown in block 303). If yes, then the PCI control signal testing is executed, in order to certify if the transportation of the control signal between the PCI controller of the chipset and the on-board PCI device is correct (shown in block 305). If yes, then the PCI address/data bus (AD bus) testing is executed, to certify if the transportation of the address and data is correct (as shown in block 307). Finally, a test record 309 is made according to the results of the above tests, and used as a basis of debug and quality control.

In the above tests of the interrupt procedures, the interrupt register of the on-board PCI device can be enabled by using the interrupt service routine, to trigger the on-board PCI device to send out an interrupt request signal. The interrupt service routine monitors if the interrupt request signal sent by the on-board PCI device is received within a predetermined period. If yes, the send/receive of the interrupt request signal is correct. If no, it means the interrupt function is fail, and needs further detection of bugs.

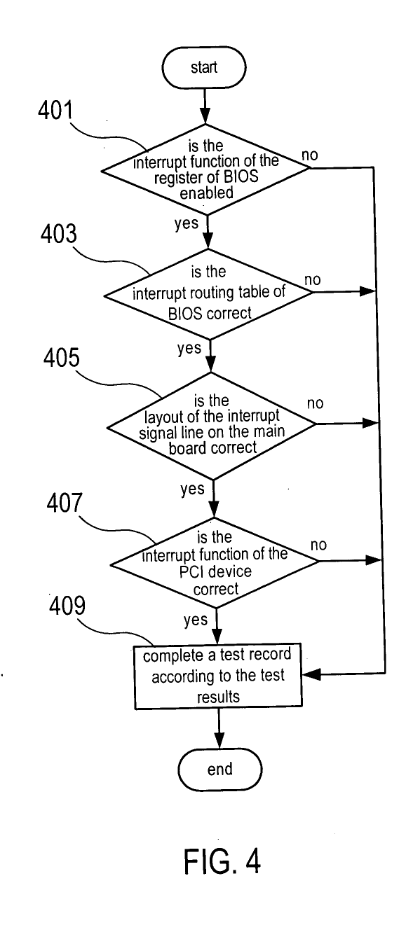

Finally please refer to FIG. 4, which shows the flow diagram of the bug detection of interrupt fail provided by the present invention. It is shown in the figure the detecting procedures for certifying the interrupt service routine when bugs happen. Firstly software is used to detect if the interrupt function of the register of BIOS is enabled (shown in block 401). If yes, then the software detects further if the interrupt routing table of BIOS is correct (shown in block 403). If yes, it means the settings of BIOS are correct, and the hardware needs further detection. The software then detects if the layout of the interrupt signal line on the main board is correct (shown in block 405). If yes, then the settings of BIOS in the main board and the layout of the interrupt signal line are correct, therefore the bug may happen to the on-board PCI device. After that, the software detects if the interrupt function of the PCI device is correct (shown in block 407), that is, by triggering the PCI device to send an interrupt request signal, and then monitoring if the electric potential of the interrupt pin will decrease, therefore to certify if the interrupt function of the on-board PCI device is correct. After all, a test record is completed according to the above test results (shown in block 409).

By using the detecting method of PCI system of the present invention, the cause of bugs and problems can be rapidly located and certified. Furthermore, it can be clarified that if the bug can be solved by the manufacturer of the main board, or it must be reported to the manufacturer of the on-board PCI device. Therefore, the present invention can avoid waste of time or even the conflict between the manufacturers about the cause of bugs, when manufacturers test the function of the PCI device.

Thus, the system and method of the present invention provides a detecting method for PCI system, especially a detecting method to rapidly detect bugs of PCI system. The present invention uses an interrupt service routine to test interrupt function, to rapidly detect bugs, and to prevent from the problem that the system passes function test but fails to work properly.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A detecting method for peripheral component interconnect (PCI) system, said PCI system including a central process unit, a basic input/output system (BIOS), a chipset including a PCI controller, a PCI bus and at least one PCI device, said method comprising the steps of:
providing an interrupt service routine;
sending an interrupt request signal from said PCI device by said interrupt service routine for testing the interrupt function of said PCI system; and
determining whether the interrupt function performed by said PCI systemis correct.

2. The detecting method of claim 1, wherein said PCI device further comprises an interrupt register, writing enabled by said interrupt service routine to ask said PCI device to send an interrupt request signal.

3. The detecting method of claim 1, wherein said interrupt service routine comprises a predetermined period, determining the interrupt function of said PCI system is correct if said interrupt request signal is received within said predetermined period; determining the interrupt function of said PCI system is incorrect if said interrupt request signal is not received within said predetermined period.

4. The detecting method of claim 3, further comprising an interrupt function bug detection procedure performed when the interrupt function of said PCI system is incorrect.

5. The detecting method of claim 4, wherein said BIOS comprises a register and an interrupt routing table, and said interrupt function bug detection procedure comprises the following steps of:
detecting whether the interrupt function within said register of said BIOS is enabled; and
detecting whether the interrupt routing table within said BIOS is correct.

6. The detecting method of claim 5, wherein said interrupt function bug detection procedure further comprises the following steps of:
detecting whether the layout of the interrupt signal line of the main board is correct; and
detecting whether the interrupt function of said PCI device is correct.

7. The detecting method of claim 6, further comprising a step of recording and reporting a test result.

8. The detecting method of claim 1, further comprising a PCI register read/write testing procedure for detecting whether the function of said PCI system is correct.

9. The detecting method of claim 1, further comprising a PCI control signal testing procedure for detecting whether the transportation of the control signal of said PCI system is correct.

10. The detecting method of claim 1, further comprising a PCI data bus testing procedure for detecting whether the data transportation of said PCI system is correct.
